(19) United States
(12) Patent Application Publication
(10) Pub. No.: US 2007/0040650 A1
(43) Pub. Date: Feb. 22, 2007

(54) Wireless controlled security system

(76) Inventors: Steven L. Handley, Orland, IN (US); Sonja A. Handley, Orland, IN (US)

Correspondence Address: Raymond M. Galasso;Galasso & Associates LP, P.O. Box 26503, Austin, TX, 78755-0503, US

(21) Appl. No.: 11/207,404

(22) Filed: Aug. 18, 2005

(51) Int. Cl. G05B 19/00

(52) U.S. Cl. 340/5.64; 340/5.72

(57) ABSTRACT

A home and auto security system that enables a user to activate and deactivate various items, such as the locking and unlocking of a door, the turning on and off of lights, and the activation and deactivation of a security system, with the use of a wireless transmitter in a key fob. The key fob includes various buttons such that when depressed, signals are transmitted from the key fob. A receiver/controller is positioned in a building or home and a vehicle, such that upon the reception of a signal from the transmitter of the key fob, a predetermined function is carried out by the receiver/controller. The key fob includes a security device to prevent unauthorized users from operating the transmitter in the key fob.

### FIELD OF THE INVENTION

The present invention relates security systems for buildings, more specifically but not by way of limitation to a security system for preventing unauthorized access to a building as well as for controlling certain environment settings of the building, such as the lighting, with the security system being controllable by a wireless remote.

### BACKGROUND

The safety of a society's people and possessions are a principal concern of any populace. In order to ensure that there is an overall feeling of protection and security within a governmental boundary, various agencies are created, manned, and maintained. Among the basic organized forces that can intervene for and on behalf of individuals and groups are police agents, and fire and rescue agents. With a strong set of organized and well equipped protective departments readily available, a community can function under an atmosphere of security and peace.

Even with all of the organized forces, safety begins with an individual. A property owner, for example, will implement safety measures designed to protect their possessions from theft or damage. These measures include the use of locks on windows and doors, as well as electronic alarm or security systems. Many of these safety measures utilized by individuals require keys to be activated and deactivated. Key and locks are utilized by millions of people, not only in household applications, but also for automobiles, offices, mailboxes, garages and safety deposit boxes, just to name a few. However, there are many disadvantages in using a key and lock setup. For example, when returning home at night, it is often very difficult to find a key, especially when at the bottom of a pocketbook. Additionally, once found, it is often difficult to be able to see the keyhole to insert the key. The difficulties are compounded when the homeowner's hands are full of bags or packages. As can be appreciated, the longer a homeowner stands outside their locked door attempting to gain access to their home, the less safe they are.

Therefore there is a need for a security system that facilitates the access to ones building in a manner as to minimize the amount of time a user is proximate to the locked entrance.

### BRIEF DESCRIPTION OF THE DRAWING FIGURES

A more complete understanding of the present invention may be had by reference to the following Detailed Description and appended claims when taken in conjunction with the accompanying Drawings wherein:

FIG. 1 illustrates a perspective view of a wireless transmitter keychain and a receiver in accordance with principles of the present invention;

FIG. 2 illustrates a bottom partial perspective view of the wireless transmitter keychain as similarly shown in FIG. 1 in accordance with the principles of the present invention; and

FIG. 3 is a block diagram illustrating the present invention.

### DETAILED DESCRIPTION

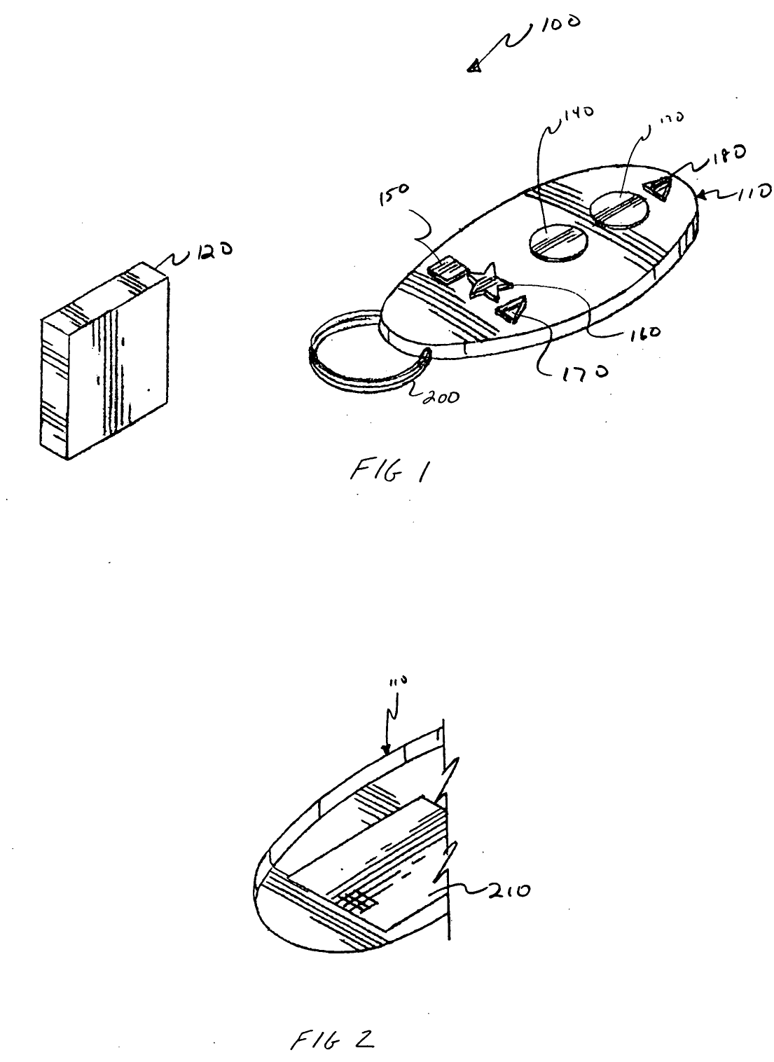

Referring now to the drawings wherein like elements are designated with identical reference numerals throughout the views and figures and wherein the various elements depicted are not necessarily drawn to scale, and in particular FIG. 1, there is illustrated a preferred embodiment of a wireless controlled security system 100. As illustrated the wireless controlled security system 100 includes a wireless transmitter 110 and a receiver/controller 120.

Wireless transmitter 110 includes various actuators or buttons, such as buttons 130, 140, 150, 160 and 170, and a light 180. Each of the various buttons can be of different shapes and position on the wireless transmitter 110 to facilitate the user being able to determine which button or series of buttons to depress just by feeling the shape and position of the buttons. For example, round buttons 130 and 140 could be the unlock and lock buttons for a door, while square button 150 could be programmed for arming a security system and triangular button 170 could be programmed for disarming the security system. Additionally, star shaped button 160 could be programmed to turn on lights in the house when depressed. As is further illustrated, wireless transmitter 110 includes a key ring 200, such that the entire wireless transmitter 110 is incorporated in a typical sized key fob. As can be appreciated, one advantage of wireless controlled security system 100 utilizing a wireless transmitter 110 is that it facilitates easy unlocking of a door and easy arming/disarming of a security system, especially when the user's hands are filled, such as when carrying packages.

It is contemplated that buttons 130, 140, 150, 160 and 170 of wireless transmitter 110 could also be constructed with illuminating material such that they glow in the dark or could be illuminated by a light within wireless transmitter 110. Additionally, buttons 130, 140, 150, 160 and 170 could be of varying colors.

Receiver/controller 120 would be programmed to receive signals transmitted from wireless transmitter 110 and would control, among other things, the locking and unlocking of a door, the operation of lights, and the arming and disarming of a security system. In a preferred embodiment, receiver/controller 120 would be connected to or integrated with a door, such that the control of locking and unlocking the door would be easily facilitated.

In operation, when a user depresses one of the buttons on wireless transmitter 110, a signal is transmitted from the wireless transmitter 110, and if the user is within operating range of receiver/controller 120, receiver/controller 120 will receive the transmitted signal. In response to the received signal, receiver/controller 120 will perform a programmed function. For example, if a user is approaching a door, and depresses button 130, wireless transmitter 110 will send a signal corresponding to the depression of the unlock button 130. In response to the receiving of the unlock signal, receiver/controller 120 will control the unlocking of the door.

For security purposes, it is contemplated that wireless transmitter 110 could be configured or programmed with various security features to prevent or prohibit unauthorized use. For example, wireless transmitter 110 could be programmed such that a pattern or certain combination of buttons is depressed in order to activate the normal operation of wireless transmitter 110. Additionally it is contemplated that the signals transmitted from wireless transmitter 110 be encrypted to prevent an unauthorized receiver from utilizing or copying the signals.

Referring now to FIG. 2, there is illustrated a partial bottom perspective view of wireless transmitter 110. As illustrated, wireless transmitter includes a power supply or battery access 210 to facilitate the removal and replacement of a power source, such as batteries. As can be appreciated by one of ordinary skill in the art, wireless transmitter 110 could be constructed of various material, although good results have been achieved my making wireless transmitter 1110 out of plastic. It is further contemplated that various power supplies could be implemented, such as a rechargeable power supply, that could be recharged in a car.

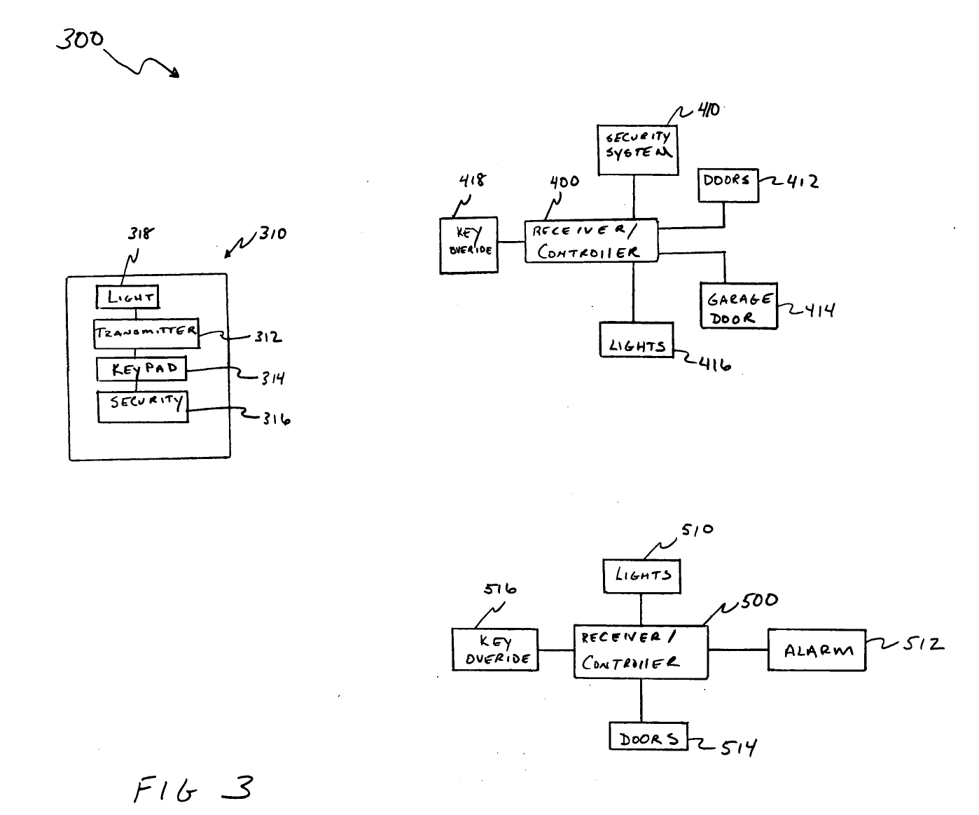

Referring now to FIG. 3, there is illustrated a preferred alternative embodiment of a wireless controlled security system 300. Wireless controlled security system 300 includes a wireless transmitter 310, a home receiver controller 400 and a car receiver/controller 500.

Wireless transmitter 310 is a single wireless transmitter for activating/controlling multiple receiver/controllers. Wireless transmitter 310 includes a transmitter 312, a keypad 314, security 316, and a light 318. Keypad 314 can be either an alphanumeric keypad, pictorial buttons, a geometric shaped button keypad or a combination thereof. In operation, a button or combination of buttons from the keypad 314 is depressed, activating transmitter 312 to send a corresponding preprogrammed signal. As described above with reference to FIG. 1, wireless transmitter 310 could be implemented in a typical key fob. Additionally, various security features could be implemented in security 316. Such as requiring the pressing of a certain combination of buttons on the keypad to activate the operation of wireless transmitter 310. It is also contemplated that other security measures could be implemented into security 316 to prevent the unauthorized use, such as a finger print recognition system.

Wireless transmitter 310 could be manufactured in various shapes and colors, including a single color or multiple colors and patterns, such that, for example, a user could pick a shape and or color pattern to match either their home or their car.

Home receiver controller 400 is for placement in a home or building. Home receiver controller 400 is for controlling various components in a home or building such as a security system 410, the locking/unlocking of doors 412, the opening and closing of a garage door 414, turning on/off lights 416. A key override 418 could also be implemented such that if the transmitter is inoperable, a door could be unlocked and a security system be deactivated with the use of the key. It is contemplated that security system 410 include not only a typical alarm, but also a silent alarm or panic alarm, such that if a certain button or combination of buttons are depressed on keypad 314, it will appear that the security system 410 has been deactivated, however, it will activate a silent alarm.

Car receiver controller 500 is for placement in a car or other type of moving vehicle, such as but not limited to vans, minivans, SUVs and trucks. Car receiver controller 500 is for controlling various components in the vehicle, such as lights 510 which could include interior lights as well as headlights, an alarm system 512, and for controlling the locking and unlocking of doors 514. A key override 516 could also be implemented such that if the transmitter is inoperable, a door could be unlocked and a security system is deactivated with the use of the key. It is also contemplated that car receiver controller 500 could not only control the locking and unlocking of doors, but also, for vehicles so equipped, activate the opening and closing of automatic doors.

In operation, when a user depresses one of the buttons of keypad 314 on wireless transmitter 310, a signal is transmitted from the wireless transmitter 310. If the user is interacting with car receiver/controller 500 and if the user is within operating range of the car receiver/controller 500, car receiver/controller 500 will receive the transmitted signal. In response to the received signal, car receiver/controller 500 will perform a programmed function. For example, if a user presses the button or combinations of buttons to unlock a car door, when car receiver/controller 500 receives the appropriate signal, it will activate the unlocking of the car door. Similarly when a user depresses one of the buttons of keypad 314 on wireless transmitter 310, a signal is transmitted from the wireless transmitter 310. If the user is interacting with home receiver/controller 400 and if the user is within operating range of the home receiver/controller 400, home receiver/controller 400 will receive the transmitted signal. In response to the received signal, home receiver/controller 400 will perform a programmed function. For example, if a user presses the button or combinations of buttons to unlock a door, when home receiver/controller 400 receives the appropriate signal, it will activate the unlocking of the door.

In an alternative embodiment, it is contemplated that home receiver controller 400 and car receiver controller 500 could be configured to communicate with transmitter 310 a notice or warning that certain functions by controllers 400 and 500 have been performed. For example, if the an alarm has been activated, a signal will be communicated from home receiver controller 400 to transmitter 310. Transmitter 310 will then communicate to the user such information, such as but not limited to a blinking light, vibration, or other indication mechanism.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A home keyless entry device, said device comprising;
a key fob, said key fob including a plurality of buttons and a transmitter, said transmitter for transmitting a first signal in response to the depression of at least a first of said plurality of buttons; and
a controller positioned in the home, said controller for receiving said signal transmitted from said transmitter, said controller for controlling the unlocking of a door in the home in response to receiving said first signal transmitted from said transmitter.

2. The device as recited in claim 1, wherein said plurality of buttons is a plurality of shapes to facilitate the identification of each of said plurality of buttons by shape.

3. The device as recited in claim 1, wherein said key fob includes a security device connected to said transmitter, said security device configured to permit select users to operate said transmitter.

4. The device as recited in claim 2, wherein said security device permitting the operation of said transmitter upon the depression of a pattern of said plurality of buttons.

5. The device recited in claim 1, wherein said key fob includes a light, said light operable in response to a user depressing one of said plurality of buttons.

6. The device as recited in claim 1, wherein said controller further for controlling the locking of the door in the home in response to receiving a signal from said transmitter.

7. The device as recited in claim 1, wherein said controller further for controlling the turning on and off of a light in the home in response to receiving a signal from said transmitter.

8. A security device comprising:
a transmitter for transmitting signals, said transmitter including a plurality of buttons, said transmitter transmitting signals in response to the depression of at least one of said plurality of buttons;
a first controller positioned in a home, said first controller for controlling the unlocking and locking of a door in the home in response to said first controller receiving a signal transmitted from said transmitter; and
a second controller positioned in a vehicle, said second controller for controlling the unlocking and locking of a door in vehicle in response to said second controller receiving a signal transmitted from said transmitter.

9. The security device as recited in claim 8, and further including a key fob, with said transmitter positioned in said key fob.

10. The security device as recited in claim 8, wherein said first controller further for controlling turning a light in the home on and off in response to said first controller receiving a signal transmitted from said transmitter.

11. The security device as recited in claim 8, wherein said first controller further for controlling the activation and deactivation of a security system in the home in response to said first controller receiving a signal transmitted from said transmitter.

12. The security device recited in claim 8, wherein said second controller further for controlling the activation and deactivation of a security system in the vehicle in response to said second controller receiving a signal transmitted from said transmitter.

13. The security device as recited in claim 9, wherein said key fob includes a security device connected to said transmitter, said security device configured to permit select users to operate said transmitter.

14. The security device as recited in claim 13, wherein said plurality of buttons is a plurality of shapes to facilitate the identification of each of said plurality of buttons by shape.

15. A security device comprising:
a key fob, said key fob including a transmitter for transmitting signals, said transmitter including a plurality of buttons, said transmitter transmitting signals in response to the depression of at least one of said plurality of buttons;
a first controller positioned in a home, said first controller for controlling the unlocking and locking of a door in the home in response to said first controller receiving a signal transmitted from said transmitter, said first controller further operable to unlock and lock the door in the home by a mechanical key; and
a second controller positioned in a vehicle, said second controller for controlling the unlocking and locking of a door in vehicle in response to said second controller receiving a signal transmitted from said transmitter, said second controller further operable to unlock and lock the door in the car by a mechanical key.

16. The security device as recited in claim 15, wherein said plurality of buttons is a plurality of shapes to facilitate the identification of each of said plurality of buttons by shape.

17. The security device as recited in claim 16, wherein said key fob includes a security device connected to said transmitter, said security device configured to permit select users to operate and transmitter.

18. The security device as recited in claim 17, wherein said security device permitting the operation of said transmitter upon the depression of a pattern of said plurality of buttons.

19. The security device as recited in claim 18, wherein said key fob includes a light, and light operable in response to a user depressing one of said plurality of buttons.

20. The security device as recited in claim 19, wherein said first controller further for controlling the activation and deactivation of a security system in the home in response to said first controller receiving a signal transmitted from said transmitter, and further wherein said second controller further for controlling the activation and deactivation of a security system in the vehicle in response to said second signal transmitted from said transmitter.
